(19) United States
(12) Patent Application Publication
(10) Pub. No.: US 2025/0347588 A1
(43) Pub. Date: Nov. 13, 2025

(54) SETUP OF A ROLLING TEST FOR SPUR GEARS

(71) Applicant: KLINGELNBERG AG, Zürich (CH)

(72) Inventor: Christof Gorgels, Köln (DE)

(21) Appl. No.: 19/200,070

(22) Filed: May 6, 2025

(30) Foreign Application Priority Data
May 7, 2024 (DE) 10 2024 112 839.9

(51) Int. Cl. G01M 13/021

(52) U.S. Cl. CPC G01M 13/021

(57) ABSTRACT

A method includes rolling test of spur gears with a rolling test rig, wherein test results are statistically checked for repeatability, reproducibility, and determination of a standard deviation for the test results; hard finishing of spur gears, wherein a respective gearing of a respective spur gear is hard-finished; rolling test of hard-finished spur gears by the rolling test rig for which standard deviation has been determined; end-of-line testing of the hard-finished spur gears by a gear test rig; evaluation of the end-of-line test results of the hard-finished spur gears, wherein spur gears are declared as good or bad parts based on at least one quality criterion; evaluating test results of hard-finished spur gears, wherein results are evaluated which have been declared as good parts according to end-of-line test, wherein the rolling test results include an order analysis, and a tolerance limit is determined for one or more orders per case.

### CROSS-REFERENCE TO RELATED APPLICATIONS

This application claims the benefit of German patent application no. 10 2024 112 839.9, filed on 7 May 2024, the disclosure of which is incorporated herein by reference in its entirety.

### TECHNICAL FIELD

The present disclosure relates to a method for the rolling test of gears and, in particular, to the setup of a rolling test for the series production of spur gearings or spur gears.

### BACKGROUND

The increasing importance of the noise behavior of vehicle transmissions means that spur gears are also increasingly being subjected to a rolling test or end-of-line test, which checks the dynamic behavior and in particular the noise behavior of a relevant spur gear. A corresponding production process and a quality control loop are known, for example, from document WO2022207371A1.

In the production of spur gears, the problem arises that tolerances for the rolling test are not known in advance. The setup of the rolling test for the series production of spur gears is therefore complex or, in many cases, can only be carried out by experienced or specially trained employees.

### SUMMARY

Against this background, the present disclosure is based on the technical problem of specifying a method that enables a robust and reliable rolling test of spur gears and, in particular, reduces the overall testing effort.

The technical problem described above is solved with the features of the independent claim. Further designs of the disclosure result from the dependent claims and the following description.

The present disclosure relates to a method comprising the following method steps: Rolling test of spur gears by means of a rolling test rig, wherein results of the rolling test are statistically checked for repeatability and reproducibility and determination of a standard deviation for the results of the rolling test; hard finishing of a plurality of spur gears, wherein a respective gearing of a respective spur gear is hard-finished; rolling test of the plurality of hard-finished spur gears by means of the rolling test rig for which the standard deviation has been determined; end-of-line testing of the plurality of hard-finished spur gears by means of a gear test rig; evaluation of the results of the end-of-line test of the plurality of hard-finished spur gears, wherein the spur gears are declared as good parts or bad parts on the basis of at least one quality criterion; evaluation of the results of the rolling test of the plurality of hard-finished spur gears, wherein the results of those spur gears are evaluated which have been declared as good parts according to the end-of-line test, wherein the results of the rolling test each comprise an order analysis, and wherein a tolerance limit is determined for one or more orders in each case.

According to the disclosure, the end-of-line test thus forms the reference for defining good parts and bad parts, wherein one or more order-specific tolerance limits are defined for the rolling test by using the results of the rolling test of those spur gears which have been declared as good parts of the end-of-line test.

For example, the end-of-line test can be used to determine one or more order-specific tolerance limits for the rolling test by comparing the results of the end-of-line test with the results of the rolling test.

The tolerances for the rolling test can therefore be determined and set by the process sequence specified in accordance with the disclosure.

In this way, a reliable and robust rolling test of spur gears can be carried out.

The rolling test can preferably be a single flank rolling test. Alternatively, the rolling test can be a double flank rolling test.

The rolling test rig for rolling testing and the gear test rig for end-of-line testing are two separate, distinct devices. In the rolling test, a spur gear to be tested rolls in a known manner with a master gear in order to determine, for example, rotational errors or similar deviations. The end-of-line test relates to the acoustic testing of the respective spur gear to be tested in its fully assembled state in the gearbox housing. This means that the gearing to be tested is tested on the end-of-line test rig according to the real installation situation with the corresponding surrounding bearings and adjacent spur gears or in the gear set pairing intended for use. In particular, the fully assembled gearbox intended for delivery can be tested on the test rig using the end-of-line test.

A respective spur gear can be an externally toothed spur gear.

A respective spur gear can have a spur gearing. Alternatively, a respective spur gear can have a helical gearing.

The respective gearing of a respective spur gear can have modifications, such as crowning, retractions or the like.

In the method according to the disclosure, the rolling test is first checked for repeatability and reproducibility. This test can also be referred to as a “Gauge R&R” test, a technical term that describes the testing of the capability of a particular measuring system for a specific measuring task. In particular, it is tested whether the combination of the rolling test rig with the master wheel used and the clamping intended for the gearing to be tested provides reproducible, repeatable results. For example, a defect or wear of the rolling test rig or a component of the rolling test rig, the master wheel or the clamping can cause the results of the rolling test to scatter greatly or be random results. In this case, the test setup must be corrected until repeatability and reproducibility are guaranteed.

During the rolling test, the spur gears used to check the repeatability and reproducibility roll with the same or the identical master gear that is also used for the rolling test in series production. Accordingly, the spur gears used to check the repeatability and reproducibility are based on the same nominal geometry as the further spur gears.

The hard finishing of the spur gears can be carried out, for example, by means of a grinding process. This can be a continuously indexing grinding process, such as generating grinding by means of a grinding worm, or it can be a single-indexing grinding process, such as profile grinding or generating grinding by means of a grinding wheel.

The respective spur gears have been hardened before hard finishing,

The testing of the respective spur gears in the end-of-line test is a test of the acoustic behavior. Quality criteria of such an end-of-line noise test are, for example, the sound pressure level, the airborne noise, the structure-borne noise, the volume level, the loudness of the transmission noise but also, for example, the tonality, i.e. the extent to which dominant frequencies of the transmission noise are prominent and audible as disturbing individual tones. A well-known analysis of noise behavior using the end-of-line test is the so-called NVH criterion, wherein the abbreviation NVH stands for “noise”, “vibration” and “harshness”. It may be provided, for example, that the end-of-line test for one or each of the aforementioned noise assessment characteristics may have a limit value that must be met by a spur gear in order to be declared as a good part.

The order analysis presents the results of the rolling test as an order spectrum. Here, individual orders and/or order ranges of the order spectrum can be assigned test characteristics of the gearing, such as concentricity errors; wobble; pitch errors of the first order and/or higher orders; surface waviness, flank form errors or the like.

The results of the rolling test are generated in particular by providing rotation-related axis data from the rolling test rig as an order spectrum using FFT. The abbreviation FFT stands for the fast Fourier transformation. The orders are multiples of the speed of the spur gear on the rolling test rig, so that measured deviations or measured values are plotted as amplitudes over the individual orders,

The end-of-line test and the application of the NVH criterion as well as the assessment of other acoustic characteristics as part of the end-of-line test are state of the art and well known. This applies equally to the rolling test and the associated order analysis. The disclosure in the present case is the use of the end-of-line test to determine tolerances for the rolling test on the basis of good parts from the end-of-line test and thus to simplify the setup of the rolling test.

It may therefore be provided that those spur gears that have been declared as good parts in the end-of-line test are used as a reference for defining tolerances for several orders that are used in the rolling test for series production.

For example, it is possible to analyze which three spur gears that have been declared as good parts in the end-of-line test have the maximum amplitudes for the first order of the rolling test in the rolling test. An average value of these amplitudes can be defined as the tolerance limit for the first order, compliance with which is checked during the rolling test of further spur gears in series production. Alternatively, the maximum value of the amplitude for a particular order can be determined and defined as the tolerance limit for this order, wherein again only the good parts of the end-of-line test are evaluated, which serve as a reference.

During the setup of the rolling test, the hard finishing, the rolling test and the end-of-line test for different spur gears can run at least partially simultaneously. The sequence of the rolling test and the end-of-line test is arbitrary during the setup of the rolling test, wherein the rolling test of a relevant spur gear preferably takes place before the end-of-line test.

While the steps described above describe the setup of the rolling test and the comparison of the rolling test with the end-of-line test, the actual series production is hereinafter referred to as hard finishing of “further spur gears”. For these further spur gears or the corresponding production batches, the rolling test set up in this way is therefore used to check the quality of the further spur gears in question against the specified tolerances as part of the rolling test.

It is therefore possible, after setting up the rolling test, to carry out hard finishing of further spur gears and a rolling test of the further spur gears, wherein the results of the rolling test of a respective further spur gear each comprise an order analysis, wherein compliance with the respective specified tolerance limit is checked for one or more orders of a respective order analysis.

It may be provided that an end-of-line test is carried out for a respective one of the further spur gears for which a defined tolerance limit is not complied with. This means that those spur gears which do not comply with a specified tolerance limit during the rolling test, i.e. are declared as bad parts according to the rolling test, can be sent to the end-of-line test for adjustment.

The end-of-line test shows for this spur gear either that the result of the rolling test is correct and the spur gear in question is actually a bad part, or that the rolling test may not be correct, the spur gear in question is to be declared as a good part according to the end-of-line test and the tolerance limit of the rolling test can be adjusted accordingly if necessary. In this way, a quality control loop for the rolling test can be generated by regularly comparing the rolling test with the end-of-line test in order to achieve the best possible correlation between the end-of-line test and the rolling test.

It may be provided that the tolerance limit of the order that has not been met for the further spur gear according to the order analysis of the rolling test is adjusted if the end-of-line test of the further spur gear shows that the further spur gear is to be declared as a good part according to the quality criterion of the end-of-line test.

In particular, the scope of the end-of-line test can be reduced by the procedure according to the disclosure. If a good correlation between the rolling test and the end-of-line test is achieved, not every spur gear needs to be subjected to the end-of-line test, as the result of the rolling test is already a sufficiently good prediction of the result of the end-of-line test. In particular, it can therefore be provided that a respective one of the further spur gears for which a defined tolerance limit is met is not subjected to an end-of-line test.

Alternatively or additionally, it may be provided that individual spur gears are randomly or at fixed intervals or after a fixed number of manufactured components are fed to the end-of-line test, regardless of the result of the rolling test, in order to check the correlation of the rolling test with the end-of-line test.

It may be provided that a 100% test is carried out for the further spur gears with regard to the rolling test. This means that all further spur gears are subjected to the rolling test. However, due to the correlation between the rolling test and the end-of-line test, it is not necessary that all spur gears are also subjected to the end-of-line test. Rather, it is provided according to the disclosure that only a subset of the further spur gears are fed to the end-of-line test. The number of those further spur gears that are fed to the rolling test is therefore greater than the number of those further spur gears that are fed to the end-of-line test. In this way, the test time can be significantly reduced.

As previously discussed, even after the rolling test has been set up using the end-of-line test, further monitoring and adjustment of one or more tolerance limits may be performed to improve or permanently ensure correlation of the rolling test with the end-of-line test.

### BRIEF DESCRIPTION OF THE DRAWINGS

The disclosure is described in more detail below with reference to a drawing illustrating exemplary embodiments. It shows schematically in each case:

FIG. 1 method steps of a method according to the disclosure;

FIG. 2 a gear cutting machine;

FIG. 3 generating grinding of a spur gear;

FIG. 4 a device for the single flank rolling test;

FIG. 5 a device for double flank rolling test; and

FIG. 6 an end-of-line test.

### DETAILED DESCRIPTION OF THE DRAWINGS

In a method step (A), a rolling test of spur gears is first carried out by means of a rolling test rig, wherein results of the rolling test are statistically checked for repeatability and reproducibility and a standard deviation for the results of the rolling test is determined.

The result is shown schematically in FIG. 1 under (A), wherein an order spectrum for the rotation error has been created and each order has been assigned a standard deviation in the form of an error bar F.

Subsequently, according to step (B), a hard finishing of a plurality of spur gears is carried out, wherein a respective gearing of a respective spur gear is hard-finished, and a rolling test of the plurality of hard-finished spur gears is carried out by means of the rolling test rig for which the standard deviation has been determined. Furthermore, an end-of-line test of the plurality of hard-finished spur gears is carried out using a gear test rig and the results of the end-of-line test of the plurality of hard-finished spur gears are evaluated, wherein the spur gears are declared as good parts or bad parts based on a quality criterion. This can, for example, be a known NVH evaluation or an NVH criterion from the end-of-line test.

FIG. 1 shows under (B) the results of the rolling test of the plurality of hard-finished spur gears as an order analysis of those spur gears that were declared as good parts in the end-of-line test.

The maximum values of each order from (B) are used together with the standard deviation from (A) to define the tolerances T for the individual orders of the rolling test. The determination of the tolerances is shown in FIG. 1 according to diagram (C). It is therefore examined for each order under consideration which of the hard-finished spur gears that has been declared as a good part according to the end-of-line test forms the maximum deviation for a given order, and this deviation is defined as the upper tolerance limit for the respective order.

Thus, according to step (C), the setup of the rolling test is initially completed and hard finishing of further spur gears can take place and a rolling test of the further spur gears can take place, wherein the results of the rolling test of a respective further spur gear each comprise an order analysis and wherein compliance with the respective tolerance limit determined according to step (C) is checked for one or more orders of a respective order analysis.

For further spur gears for which a tolerance limit defined in step (C) is not met, an end-of-line test can be performed. If the end-of-line test shows, contrary to the rolling test, that the spur gear is a good part, the corresponding tolerance limit of the rolling test can be adjusted using this spur gear by using the amplitude of the relevant order as the new, corrected tolerance limit TK for the subsequent rolling tests. This procedure is illustrated in FIG. 1 under step (D).

Thus, in step (D) it can be seen that TK is above the originally defined tolerance limit T. The tolerance limit T is therefore raised to the value TK for the order in question.

In other words, the tolerance limit of the order that has not been met for the further spur gear according to the order analysis of the rolling test is adjusted if the end-of-line test of the further spur gear shows that the further spur gear is to be declared as a good part according to the quality criterion of the end-of-line test.

The end-of-line test therefore continues to form the reference, wherein the tolerances of the orders of the rolling test are adjusted on the basis of the end-of-line test in order to achieve the best possible correlation of the rolling test with the end-of-line test.

FIG. 2 shows a gear cutting machine 2 for the hard finishing of spur gears, i.e. a gear grinding machine 2. The gear grinding machine 2 has a tool spindle 4 for holding and rotationally driving a grinding tool. The gear grinding machine 2 has a workpiece spindle 6 for holding and rotating a toothed spur gear to be ground. The gear grinding machine 2 has a dressing device 8 for dressing grinding tools.

The gear grinding machine 2 has numerically controlled machine axes X, Y, Z, A, B, C, C2, B2 for executing translatory and rotatory relative movements in order to provide the required machining kinematics during gear cutting or dressing, Furthermore, the gear grinding machine 2 has an axis Z1 with a movable quill 12 for clamping shafts or mandrels.

FIG. 3 shows a schematic example of the tool spindle 4 with a dressable grinding worm 14 held on it and the workpiece spindle 6 with a toothed spur gear 16 which is to be ground and is held on it, the teeth 17 of which are ground,

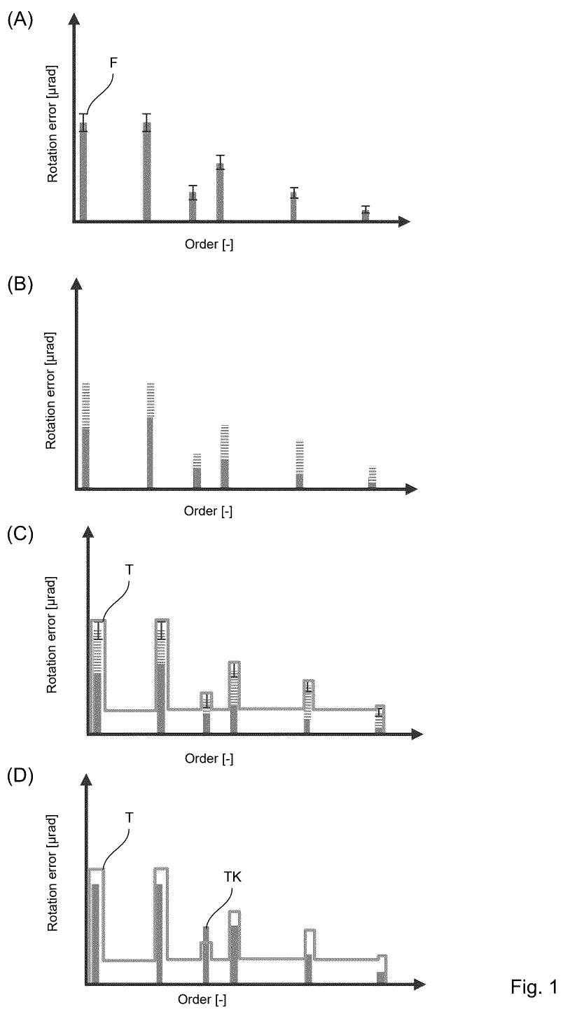

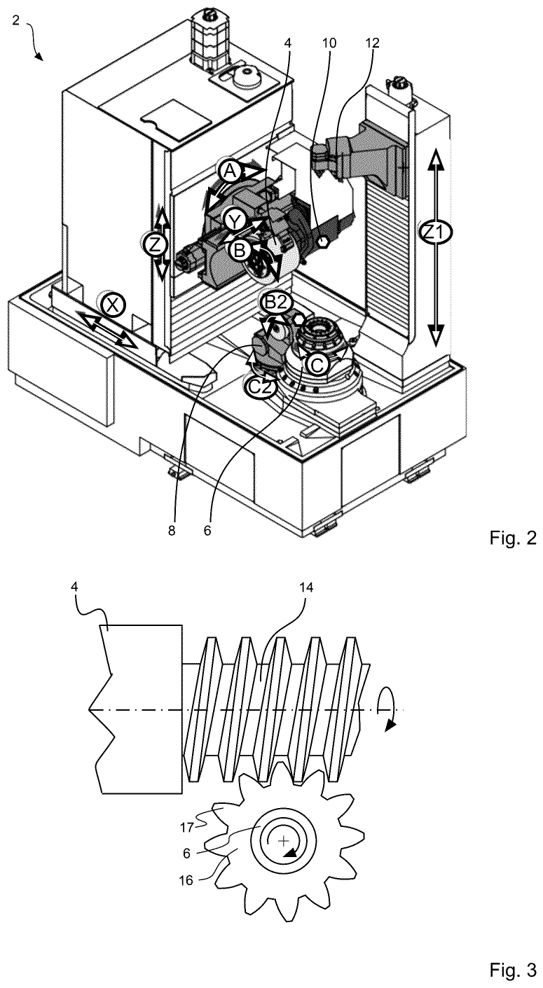

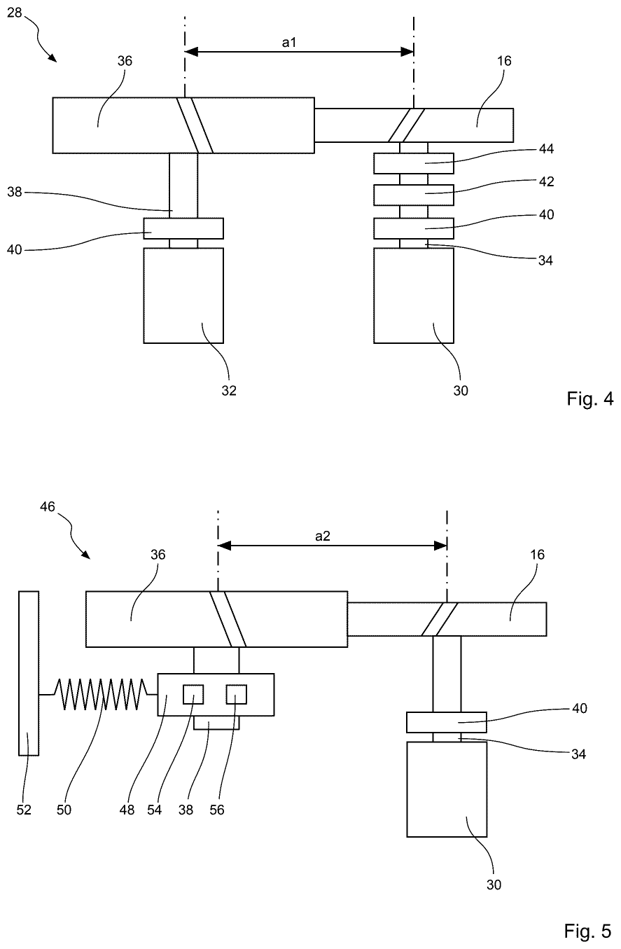

FIG. 4 shows an example of the schematic structure of a test rig 28 for carrying out a single flank rolling test for a respective spur gear 16.

The test rig 28 has a first drive 30 and a second drive 32. The first drive 30 is arranged to drive a first shaft 34 on which the toothed spur gear 16 to be tested is mounted,

The second drive 32 serves to brake a mating gear 36, which is mounted on a second shaft 38 coupled to the drive 32.

The mating gear 36 is an externally toothed spur gear, i.e. the master gear, which meshes with the gearing of the spur gear 16. By driving the spur gear 16 and simultaneously braking the mating gear 36, a speed and a torque can be set during the test run. It is understood, that speed and torque curves can also be adjusted. A center distance al between the shafts 38, 34 is constant.

The test rig 28 has rotary encoders or angle measuring systems 40, a rotational acceleration sensor 42 and a structure-borne sound sensor 44.

Alternatively or additionally, a two-flank rolling test can be carried out. A test rig 46 for the double flank rolling test is shown schematically as an example in FIG. 5. To avoid repetition, the same reference signs are assigned to the same features in the following.

The double flank rolling test differs essentially from the single flank rolling test described above with reference to FIG. 4 in that a center distance a2 is not constant during the test. The mating gear 36 is mounted and supported with its shaft 38 on a movable carriage 48. The movable carriage 48 is supported by means of a spring device 50 on an immovable counterholder 52.

By means of the spring device 50, the mating gear 36 is pressed into tooth contact with the gearing of the spur gear 16 to be tested, wherein both the right-hand and left-hand flanks of the gearing of the spur gear 16 to be tested are in contact on both sides of the tooth contact.

During the test, i.e. during the rolling of the toothed spur gear 16 with the mating gear 36, the mating gear 36 is pressed in the direction of the spur gear 16 with a defined force,

The deviation is detected by means of a translational displacement of the movable carriage 34, wherein a displacement transducer 54 and a vibration transducer 56 are associated with the carriage 48 in order to record measurement data. The single flank rolling test and the double flank rolling test are state of the art.

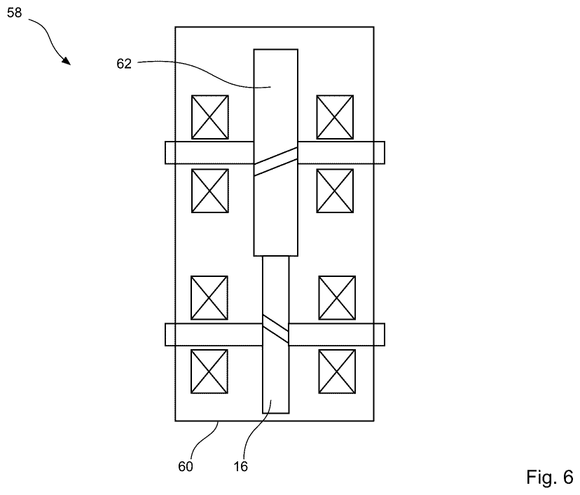

FIG. 6 shows an end-of-line test rig 58, wherein the spur gear 16 to be tested is mounted in a gear housing 60 and paired with the mating gear 62 intended for delivery. An acoustic test is performed, i.e. an analysis of the transmission noise with regard to one or more quality criteria. The end-of-line test is state of the art.

1. A method including the following steps:
rolling test of spur gears by a rolling test rig, wherein results of the rolling test are statistically checked for repeatability and reproducibility and determination of a standard deviation for the results of the rolling test;
hard finishing of a plurality of spur gears, wherein a respective gearing of a respective spur gear is hard-finished;
rolling test of the plurality of hard-finished spur gears by the rolling test rig for which the standard deviation has been determined;
end-of-line testing of the plurality of hard-finished spur gears by a gear test rig;
evaluating the results of the end-of-line test of the plurality of hard-finished spur gears, wherein the spur gears are declared as good parts or bad parts on the basis of at least one quality criterion; and
evaluating of the results of the rolling test of the plurality of hard-finished spur gears, wherein the results of those spur gears are evaluated which have been declared as good parts according to the end-of-line test, wherein the results of the rolling test each comprise an order analysis, and wherein a tolerance limit is determined for one or more orders in each case.

2. The method according to claim 1, wherein, after evaluating of the results of the rolling test of the plurality of hard-finished spur gears, a hard finishing of further spur gears and rolling test of the further spur gears, wherein the results of the rolling test of a respective further spur gear each comprise an order analysis, wherein compliance with the respective specified tolerance limit is checked for one or more orders of a respective order analysis.

3. The method according to claim 2, wherein a respective one of the further spur gears, for which a defined tolerance limit is not observed, is subjected to an end-of-line test.

4. The method according to claim 3, wherein the tolerance limit of the order which has not been complied with for the further spur gear according to the order analysis of the rolling test is adjusted if the end-of-line test of the further spur gear shows that the further spur gear is to be declared as a good part according to the quality criterion.

5. The method according to claim 1, wherein a respective one of the further spur gears, for which a defined tolerance limit is met, is not subjected to an end-of-line test.

6. The method according to claim 1, wherein all further spur gears are fed to the rolling test.

7. The method according to claim 1, wherein one or more tolerance limits are monitored and adjusted in order to improve correlation of the rolling test with the end-of-line test.

8. The method according to claim 1, wherein the rolling test is a single-flank rolling test and/or a double-flank rolling test.

9. The method according to claim 1, wherein a respective spur gear to be tested for the end-of-line test is mounted in a gearbox housing, wherein the gearbox housing reflects the installation of the spur gear according to the operating conditions in the delivered state of a finished gearbox or wherein the gearbox housing is that gearbox housing of the gearbox to be delivered.

10. The method according to claim 1, wherein, as part of evaluating the results of the rolling test of the plurality, a maximum deviation of an order is defined as a tolerance limit for this order.
